(19) United States
(12) Patent Application Publication
(10) Pub. No.: US 2023/0352039 A1
(43) Pub. Date: Nov. 2, 2023

(54) AUDIO SIGNAL PROCESSING METHOD, ELECTRONIC DEVICE AND STORAGE MEDIUM

(71) Applicant: GOERTEK INC., Shandong (CN)

(72) Inventors: Kaifa SHU, Shandong (CN); Guoming CHEN, Shandong (CN); Kang AN, Shandong (CN); Xiaofeng WANG, Shandong (CN); Jie WU, Shandong (CN); Zongxia ZHU, Shandong (CN); Feifei HAN, Shandong (CN); Dingyun LI, Shandong (CN); Zheng YANG, Shandong (CN)

(73) Assignee: GOERTEK INC., Shandong (CN)

(21) Appl. No.: 18/041,662

(22) PCT Filed: Nov. 7, 2020
(86) PCT No.: PCT/CN2020/127351

§ 371 Date: Feb. 14, 2023

(30) Foreign Application Priority Data
Aug. 25, 2020 (CN) 202010867085.9

(51) Int. Cl. G10L 21/0232; H04R 1/10

(52) U.S. Cl. CPC G10L 21/0232; H04R 1/1083; H04R 2460/13

(57) ABSTRACT

An audio signal processing method is disclosed. The method comprises the following steps: acquiring a first audio signal received by a bone conduction sensor and a second audio signal received by the microphone; determining a frequency division value according to the first audio signal and the second audio signal; and processing the first audio signal and the second audio signal according to the frequency division value to obtain an audio output signal of the electronic device. An electronic device and a computer readable storage medium are also disclosed, which achieves the effect of improving the quality of audio signals collected by the electronic device.

### CROSS-REFERENCE TO RELATED APPLICATIONS

This application is a U.S. National-Stage entry under 35 U.S.C. § 371 based on International Application No. PCT/CN2020/127351, filed Nov. 7, 2020 which was published under PCT Article 21(2) and which claims priority to Chinese Application No. 202010867085.9, filed Aug. 25, 2020, which are all hereby incorporated herein in their entirety by reference.

### TECHNICAL FIELD

This application pertains to the technical field of audio acquisition, in particular to an audio signal processing method, an electronic device and a computer readable storage medium.

### BACKGROUND

Bone conduction is a sound transmission mode to covert the sound to mechanical vibration of different frequencies and transmit sound waves through human skull, bone labyrinth, inner ear lymph, spiral organ and auditory center. Compared with the classical sound transmission mode that generates sound waves by the diaphragm, the bone conduction eliminates many steps of sound wave transmission, and can realize clear sound restoration in noisy environments; moreover, it will not affect other people due to the diffusion of sound waves in the air. As bone conduction has the above advantages, devices collecting the users' sound signals based on bone conduction have emerged.

However, in bone conduction devices, the hardware defects of the bone conduction sensor itself will lead to serious high-frequency attenuation of audio signals collected by the bone conduction sensor. This leads to incomplete audio signals collected by bone conduction audio acquisition equipment. In the prior art, in order to solve the problem of incomplete audio signals collected by bone conduction audio acquisition equipment, the microphone and the bone conduction sensor are generally both provided in the electronic device at the same time, and a fixed frequency division point is set so that high-frequency audio signals with a frequency value higher than the fixed frequency division point is collected by the microphone, and low-frequency audio signals with a frequency value lower than the frequency division point is collected by the bone conduction sensor. However, since different users, even the same user, will have different tightness, angle and strength when wearing electronic device, the optimal working frequency division point of bone conduction sensor will also change accordingly. Therefore, the solution of using fixed frequency division point to control electronic device in the prior art has a disadvantage of poor universality, which reduces the quality of audio signals collected by the electronic device.

The above content is only used to assist the understanding of the technical solutions of the present disclosure, and does not mean that the above content is acknowledged as the prior art. In addition, other objects, desirable features and characteristics will become apparent from the subsequent summary and detailed description, and the appended claims, taken in conjunction with the accompanying drawings and this background.

### SUMMARY

The main object of the present disclosure is to provide an audio signal processing method, an electronic device and a computer readable storage medium, which can achieve the effect of improving the quality of audio signals collected by the electronic device.

To achieve the above object, the present disclosure provides an audio signal processing method. The method comprises the following steps:
acquiring a first audio signal received by a bone conduction sensor and a second audio signal received by a microphone;
determining a frequency division value according to the first audio signal and the second audio signal; and
processing the first audio signal and the second audio signal according to the frequency division value to obtain an audio output signal of the electronic device.

Optionally, the first audio signal and the second audio signal are both time domain signals, and the step of determining the frequency division value according to the first audio signal and the second audio signal comprises:
converting the first audio signal and the second audio signal to frequency domain signals; and
determining the frequency division value according to the first audio signal and the second audio signal after converted.

Optionally, the first audio signal and the second audio signal are converted from time domain signals to frequency domain signals based on Fourier transform.

Optionally, the step of determining the frequency division value according to the first audio signal and the second audio signal after converted comprises:
calculating a cumulative value of products of the first audio signal and the second audio signal after converted to frequency domain signals; and
determining the frequency division value according to the accumulated value, the first audio signal after converted and the second audio signal after converted.

Optionally, the step of processing the first audio signal and the second audio signal according to the frequency division value to obtain the audio output signal of the electronic device comprises:
collecting a component of the first audio signal whose frequency value is lower than the frequency division value as a first sub-audio output signal;
collecting a component of the second audio signal whose frequency value is higher than the frequency division value as a second sub-audio output signal; and
synthesizing the audio output signal based on the first sub-audio output signal and the second sub-audio output signal.

Optionally, before the step of processing the first audio signal and the second audio signal according to the frequency division value to obtain the audio output signal of the electronic device, the method further comprises:
performing noise reduction processing on the first audio signal and the second audio signal;
the step of processing the first audio signal and the second audio signal according to the frequency division value to obtain the audio output signal of the electronic device comprises:

processing the first audio signal and the second audio signal after noise reduction processed according to the frequency division value to obtain the audio output signal of the electronic device.

Optionally, the electronic device comprises at least two microphones, and the step of acquiring the first audio signal received by the bone conduction sensor and the second audio signal received by the microphone comprises:
acquiring the first audio signal received by the bone conduction sensor; and
acquiring the second audio signal according to at least two microphone audio signals received by the at least two microphones.

In addition, in order to achieve the above object, the present disclosure also provides an electronic device, which comprises a memory, a processor, and an audio signal processing program stored on the memory and operable on the processor. When the audio signal processing program is executed by the processor, the steps of the audio signal processing method described above are implemented.

Optionally, the electronic device is a bone conduction headphone, an intelligent wearable device and/or a hearing aid.

In addition, in order to achieve the above object, the present disclosure also provides a computer readable storage medium having an audio signal processing program stored thereon. When the audio signal processing program is executed by the processor, the steps of the audio signal processing method described above are implemented.

According to the audio signal processing method, electronic device and computer readable storage medium provided in the embodiments of the present disclosure, the first audio signal received by the bone conduction sensor and the second audio signal received by the microphone are acquired, then the frequency division value is determined according to the first audio signal and the second audio signal, and the first audio signal and the second audio signal are processed according to the frequency division value to obtain an audio output signal of the electronic device. Since the frequency division value can be dynamically determined according to the first audio signal and the second audio signal received in real time, it can be ensured that when the electronic device collects audio signals, the electronic device can work with an optimal frequency division value under different wearing angles, wearing pressures and wearing positions of different users or the same user, thereby achieving the effect of improving the signal quality of the audio signal collected by the electronic device.

### BRIEF DESCRIPTION OF DRAWINGS

The present invention will hereinafter be described in conjunction with the following drawing figures, wherein like numerals denote like elements, and:

FIG. 1 is a schematic diagram of the terminal structure of the hardware operation environment involved in the solution of an embodiment of the present disclosure;

FIG. 2 is a schematic flow diagram of an embodiment of an audio signal processing method of the present disclosure; and

FIG. 3 is a schematic flow diagram of another embodiment of an audio signal processing method of the present disclosure.

The objects, functional features and advantages of the present disclosure will be further described with reference to the attached drawings in combination with the embodiments.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

It should be understood that the specific embodiments described herein are only used to explain the present disclosure, and is not used to limit the present disclosure.

In bone conduction devices, the hardware defects originating from the bone conduction sensor itself will lead to serious high-frequency attenuation of audio signals collected by the bone conduction sensor. This leads to incomplete audio signals collected by bone conduction audio acquisition equipment. In the prior art, in order to solve the problem of incomplete audio signals collected by bone conduction audio acquisition equipment, the microphone and the bone conduction sensor are generally provided in the electronic device at the same time, and a fixed frequency division point is set so that high-frequency audio signals with a frequency value higher than the fixed frequency division point is collected by the microphone, and low-frequency audio signals with a frequency value lower than the frequency division point is collected by the bone conduction sensor. However, since different users, even the same user, will have different tightness, angle and strength when wearing electronic device, and the optimal working frequency division point of bone conduction sensor will also change accordingly. Therefore, the solution of using fixed frequency division point to control electronic device in the prior art has a disadvantage of poor universality, which reduces the quality of audio signals collected by the electronic device.

In order to solve the above problems, an embodiment of the present disclosure proposes an audio signal processing method, and it mainly comprises the following steps:
acquiring a first audio signal received by a bone conduction sensor and a second audio signal received by a microphone;
determining a frequency division value according to the first audio signal and the second audio signal; and
processing the first audio signal and the second audio signal according to the frequency division value to obtain an audio output signal of the electronic device.

Since the frequency division value can be dynamically determined according to the first audio signal and the second audio signal received in real time, it can be ensured that when the electronic device collects audio signals, the electronic device can work with an optimal frequency division value under different wearing angles, wearing pressures and different wearing positions of different users or the same user, thereby achieving the effect of improving the signal quality of the audio signal collected by the electronic device.

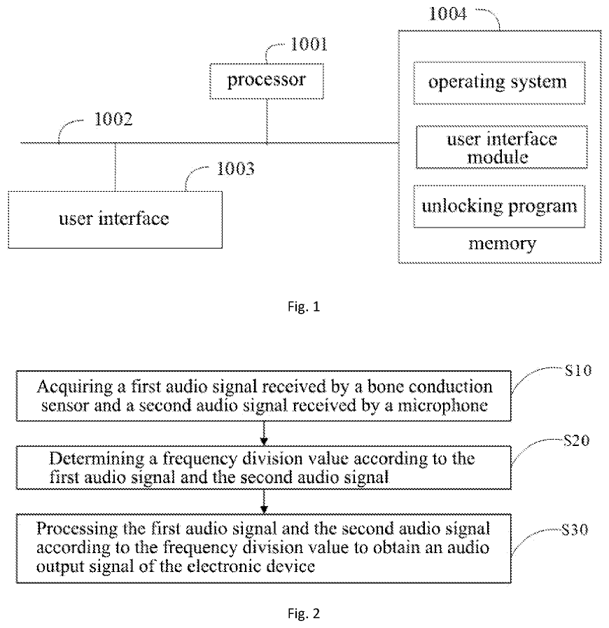

FIG. 1 is a schematic diagram of the terminal structure of the hardware operation environment involved in the solution of an embodiment of the present disclosure.

The terminal of the embodiment of the present disclosure may be an electronic device such as a bone conduction headphone.

As shown in FIG. 1, the terminal may comprise: a processor 1001 (such as a CPU), a user interface 1003, a memory 1004, and a communication bus 1002. The communication bus 1002 is used to realize the connection and communication between these components. The user interface 1003 may comprise a microphone, a bone conduction sensor, etc. Optionally, the user interface 1003 may also comprise a standard wired interface and/or a standard wireless interface. The memory 1004 may be a high-speed RAM memory or a non-volatile memory, such as a disk memory. Optionally, the memory 1004 may be a storage device independent of the processor 1001.

A person of ordinary skill in the art may understand that the terminal structure shown in FIG. 1 does not constitute a limitation on the terminal, and it may include more or fewer components than those shown in the figure, or have different combinations or arrangements of components.

As shown in FIG. 1, the memory 1004, as a computer storage medium, may comprise: an operating system, a user interface module, and an audio signal processing program.

In the terminal shown in FIG. 1, the processor 1001 may be used to call the audio signal processing program stored in the memory 1004 and perform the following operations:

acquiring a first audio signal received by the bone conduction sensor and a second audio signal received by the microphone;

determining a frequency division value according to the first audio signal and the second audio signal; and

processing the first audio signal and the second audio signal according to the frequency division value to obtain an audio output signal of the electronic device.

Further, the processor 1001 may call the audio signal processing program stored in the memory 1004, and further perform the following operations:
converting the first audio signal and the second audio signal to frequency domain signals; and
determining the frequency division value according to the first audio signal and the second audio signal after converted.

Further, the processor 1001 may call the audio signal processing program stored in the memory 1004, and further perform the following operations:
calculating a cumulative value of products of the first audio signal and the second audio signal after converted to frequency domain signals; and
determining the frequency division value according to the accumulated value, the first audio signal after converted and the second audio signal after converted.

Further, the processor 1001 may call the audio signal processing program stored in the memory 1004, and further perform the following operations:
collecting a component of the first audio signal whose frequency value is lower than the frequency division value as a first sub-audio output signal;
collecting a component of the second audio signal whose frequency value is higher than the frequency division value as a second sub-audio output signal; and
synthesizing the audio output signal based on the first sub-audio output signal and the second sub-audio output signal.

Further, the processor 1001 may call the audio signal processing program stored in the memory 1004, and further perform the following operations:
performing noise reduction processing on the first audio signal and the second audio signal;
the step of processing the first audio signal and the second audio signal according to the frequency division value to obtain the audio output signal of the electronic device comprises:

processing the first audio signal and the second audio signal after noise reduction processed according to the frequency division value to obtain the audio output signal of the electronic device.

Further, the processor 1001 may call the audio signal processing program stored in the memory 1004, and further perform the following operations:
acquiring the first audio signal received by the bone conduction sensor; and
acquiring the second audio signal according to at least two microphone audio signals received by the at least two microphones.

Referring to FIG. 2, in an embodiment of the audio signal processing method of the present disclosure, the audio signal processing method comprises the following steps:

Step S10, acquiring a first audio signal received by a bone conduction sensor and a second audio signal received by a microphone;

Step S20, determining a frequency division value according to the first audio signal and the second audio signal; and

Step S30, processing the first audio signal and the second audio signal according to the frequency division value to obtain an audio output signal of the electronic device.

In bone conduction devices, the hardware defects originating from the bone conduction sensor itself will lead to serious high-frequency attenuation of audio signals collected by the bone conduction sensor. This leads to incomplete audio signals collected by bone conduction audio acquisition equipment. In the prior art, in order to solve the problem of incomplete audio signals collected by bone conduction audio acquisition equipment, the microphone and the bone conduction sensor are generally provided in the electronic device at the same time, and a fixed frequency division point is set so that high-frequency audio signals with a frequency value higher than the fixed frequency division point is collected by the microphone, and low-frequency audio signals with a frequency value lower than the frequency division point is collected by the bone conduction sensor. However, since different users, even the same user, will have different tightness, angle and strength when wearing electronic device, and the optimal working frequency division point of bone conduction sensor will also change accordingly. Therefore, the solution of using fixed frequency division point to control electronic device in the prior art has a disadvantage of poor universality, which reduces the quality of audio signals collected by the electronic device.

In order to improve the signal quality of audio data collected by electronic device, the embodiment of the present disclosure provides the audio signal processing method.

In this embodiment, the audio signal processing method is applied to an electronic device. The electronic device is provided with a bone conduction sensor and a microphone, so that the electronic device can simultaneously collect two audio signals (bone conduction audio signal and air conduction audio signal) for the same voice by the bone conduction sensor and the microphone. In the following description, the audio signal collected by the bone conduction sensor is referred to as a first audio signal, and the audio signal collected by the microphone is referred to as a second audio signal. The electronic device may be a bone conduction headphone, an intelligent wearable device, a hearing aid or the like, which collects audio signals based on the bone conduction principle. Of course, besides the bone conduction headphone, intelligent wearable devices and/or hearing aids, the audio signal processing method proposed in this embodiment can also be applied to other electronic devices provided with a bone conduction vibration pickup device for processing bone conduction audios by electronic devices, which is not limited in this embodiment.

It should be noted that the electronic device may be provided with one microphone, or provided with a microphone array composed of multiple microphones to collect multiple second audio signals by the microphone array, so as to improve the robustness of the microphone audio acquisition system and the quality of air conduction audio signals collected by the microphone. It may be understood that when the electronic device is provided with multiple microphones, multiple air conduction audio signals collected by multiple microphones may be acquired. Therefore, when the electronic device is provided with multiple microphones, a target second audio signal may be generated first based on the multiple air conduction audio signals collected by the multiple microphones.

For example, one of the multiple air conduction audio signals collected by the multiple microphones may be taken as a main signal, the air conduction audio signals other than the main signal may be taken as slave signals, and the main signal may be optimized through the slave signals, and then the optimized main signal may be taken as the second audio signal. The steps S10 to S30 described in this embodiment are performed based on the above second audio signal. Regarding the selection of the main signal, the signal among multiple air conduction audio signals collected by multiple microphones that has the largest signal-to-noise ratio may be selected as the main signal. Since the second audio signal may be generated from multiple air conduction audio signals collected by multiple microphones, the noise of the second audio signal acquired can be reduced and the signal-to-noise ratio of the second audio signal can be improved, thereby improving the robustness of the system and the quality of air conduction audio signals collected by the microphones.

For the sake of simplicity and brevity, in this embodiment, the electronic device provided with one microphone is taken as an example to explain the protection scope defined by the claims of the present disclosure, but this should not be used to limit the present disclosure.

Further, the electronic device may acquire the first audio signal received by the bone conduction sensor and the second audio signal received by the microphone. Then, the frequency division value corresponding to the current moment is determined according to the spectral characteristics of the first audio signal and the second audio signal.

Specifically, since the bone conduction sensor and the microphone both convert the vibration into an electrical signal which is used as the audio signal based on the sound wave changes in time series of the sound source, the first audio signal received by the bone conduction sensor and the second audio signal received by the microphone are both time domain signals when directly acquired. Therefore, when the first audio signal received by the bone conduction sensor and the second audio signal received by the microphone are acquired, the first audio signal and the second audio signal may be converted from time domain signals to frequency domain signals through the fast Fourier transform. Then, the frequency division value is determined according to the first audio signal and the second audio signal after converted.

It should be noted that when the frequency division value is determined according to the first audio signal and the second audio signal after converted, a cumulative value of products of the first audio signal and the second audio signal that has been converted to frequency domain signals may be calculated first, and then the frequency division value is determined according to the cumulative value, the first audio signal after converted and the second audio signal after converted.

For example, the first audio signal becomes the frequency domain signal Y1(k) after the Fourier transform, and the second audio signal becomes the frequency domain signal Y₂(k) after the Fourier transform. Then, a correlation factor corr(k) in the frequency domain of the first audio signal and the second audio signal may be calculated according to the following equation:

$$corr ( k ) = \frac{{\sum }_{k = 1}^{32} {Y}_{1} ( k ) * {Y}_{2} ( k )}{\sqrt{{\sum }_{k = 1}^{32} {\vert {Y}_{1} ( k ) \vert}^{2} * {\sum }_{k = 1}^{32} {\vert {Y}_{2} ( k ) \vert}^{2}}}$$

Then, the correlation factor corr(k) is used as the frequency division value. Further, when the frequency division value is determined, the first audio signal and the second audio signal may be processed according to the frequency division value to obtain an audio output signal of the electronic device.

Specifically, after the frequency division value is currently determined, a label file is generated in the bandwidth decision module, and the frequency division value is used as a key parameter of the label file to process the first audio file and the second audio file.

For example, a mixer module may collect a component of the first audio signal whose frequency value is lower than the frequency division value as a first sub-audio output signal, collect a component of the second audio signal whose frequency value is higher than the frequency division value as a second sub-audio output signal, and synthesize the audio output signal based on the first sub-audio output signal and the second sub-audio output signal.

Optionally, before the step of determining the frequency division value according to the first audio signal and the second audio signal, the first audio signal and the second audio signal may be subject to noise reduction processing, and then the first audio signal and the second audio signal after noise reduction processed may be processed according to the frequency division value to obtain the audio output signal of the electronic device.

In the technical solution disclosed in this embodiment, the first audio signal received by the bone conduction sensor and the second audio signal received by the microphone are acquired, then the frequency division value is determined according to the first audio signal and the second audio signal, and the first audio signal and the second audio signal are processed according to the frequency division value to obtain an audio output signal of the electronic device. Since the frequency division value can be dynamically determined according to the first audio signal and the second audio signal received in real time, it can be ensured that when the electronic device collects audio signals, the electronic device can work with an optimal frequency division value under different wearing angles, wearing pressures and different wearing positions of different users or the same user, thereby achieving the effect of improving the signal quality of the audio signal collected by the electronic device.

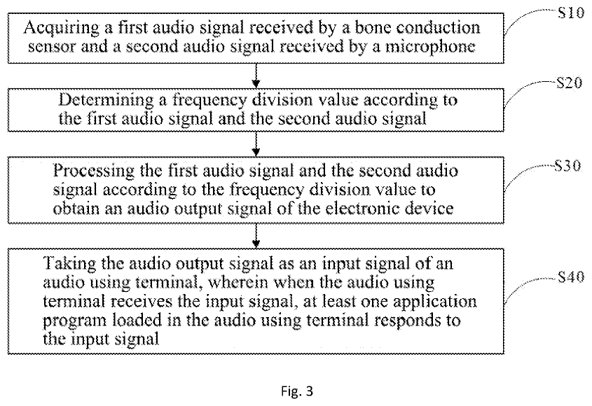

Optionally, referring to FIG. 3, based on the above embodiment, in another embodiment, after the above step S30, the method further comprises:

Step S40, taking the audio output signal as an input signal of an audio using terminal, wherein when the audio using terminal receives the input signal, at least one application program loaded in the audio using terminal responds to the input signal.

In this embodiment, the electronic device may be provided with a bone conduction headphone, and the bone conduction headphone may be connected with audio using terminal. The audio using terminal may be an intelligent device such as a computer, mobile phone and/or tablet. The bone conduction headphone may be used as the audio acquisition device of the audio using terminal. Therefore, when the bone conduction headphone generates the audio output signal, the audio output signal may be output to the audio using terminal, that is, the audio output signal is used as the input signal of the audio using terminal.

When the audio using terminal receives the input signal, at least one application program loaded in the audio using terminal responds to the input signal.

Specifically, the audio using terminal may first acquire its own usage status, and then determine the application program responding to the input signal according to the usage status. For example, when the usage status is “call”, the input signal may be used as the call voice, and the input signal may be responded by the call application; when the current status is “record”, the input signal may be responded by the record application.

In the technical solution disclosed in this embodiment, the audio output signal is taken as the input signal of the audio using terminal. When the audio using terminal receives the input signal, at least one application program loaded in the audio using terminal responds to the input signal, which can improve the audio input effect of the audio using terminal.

In addition, an embodiment of the present disclosure also provides an electronic device, which comprises a memory, a processor and an audio signal processing program stored on the memory and operable on the processor. When the audio signal processing program is executed by the processor, the steps of the audio signal processing method described in the embodiments above are implemented.

In addition, an embodiment of the present disclosure also provides a computer readable storage medium having an audio signal processing program stored thereon. When the audio signal processing program is executed by the processor, the steps of the audio signal processing method described in the embodiments above are implemented.

It should be noted that, the terms “comprise”, “include” or any other variants used herein are intended to cover non-exclusive inclusion, so that the process, method, article or apparatus including a series of elements may not only include those elements, but may also include other elements not stated explicitly, or elements inherent to the process, method, articles or apparatus. Without more limitations, an element defined by the phrase “comprising a . . . ” does not exclude the case that there are other same elements in the process, method, article or apparatus including the element.

The above serial numbers of the embodiments of the present disclosure are only for description and do not represent the priority order of the embodiments.

Through the above description of the embodiments, those skilled in the art can clearly understand that the methods of the embodiments can be implemented by means of software plus the necessary general hardware platform. Of course, it can also be implemented by hardware, but in many cases, the former is the better implementation method. Based on this understanding, the technical solution of the present disclosure, in essence or the part that contributes to the prior art, can be embodied in the form of a software product, which is stored on the above storage medium (such as ROM/RAM, magnetic disc, optical disc), and includes instructions to enable a mobile terminal (which may be a mobile phone, a computer, a server, an air conditioner, or a network device, etc.) to execute the method of each embodiment of the present disclosure.

The above only describes the preferred embodiments of the present disclosure, and does not limit the scope of the patent of the present disclosure. All equivalent substitutions of structure or process made by using the contents of the description and drawings of the present disclosure, or direct or indirect applications in other related technical fields, shall all fall within the scope of protection scope of the present disclosure.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. An audio signal processing method, applied to an electronic device comprising a bone conduction sensor and a microphone, wherein the method comprises the following steps:
acquiring a first audio signal received by the bone conduction sensor and a second audio signal received by the microphone;
converting the first audio signal and the second audio signal to frequency domain signals;
calculating a cumulative value of products of the first audio signal and the second audio signal after converted to frequency domain signals;
determining a frequency division value according to the cumulative value, the first audio signal and the second audio signal after converted; and
collecting a component of the first audio signal whose frequency value is lower than the frequency division value as a first sub-audio output signal;
collecting a component of the second audio signal whose frequency value is higher than the frequency division value as a second sub-audio output signal;
synthesizing an audio output signal based on the first sub-audio output signal and the second sub-audio output signal.

2. The audio signal processing method according to claim 1, wherein the first audio signal and the second audio signal are converted from time domain signals to frequency domain signals based on Fourier transform.

3. The processing method of the audio signal according to claim 1, wherein before the step of processing the first audio signal and the second audio signal according to the frequency division value to obtain the audio output signal of the electronic device, the method further comprises:
performing noise reduction processing on the first audio signal and the second audio signal,
the step of processing the first audio signal and the second audio signal according to the frequency division value to obtain the audio output signal of the electronic device comprises:
processing the first audio signal and the second audio signal after noise reduction processed according to the frequency division value to obtain the audio output signal of the electronic device.

4. The audio signal processing method according to claim 1, wherein the electronic device comprises at least two microphones, and the step of acquiring the first audio signal received by the bone conduction sensor and the second audio signal received by the microphone comprises:
acquiring the first audio signal received by the bone conduction sensor; and
acquiring the second audio signal according to at least two microphone audio signals received by the at least two microphones.

5. An electronic device, comprising a microphone, a bone conduction sensor, a memory, a processor, and an audio signal processing program stored on the memory and operable on the processor, wherein when the audio signal processing program is executed by the processor, the steps of the audio signal processing method according to claim 1 are implemented.

6. The electronic device according to claim 5, wherein the electronic device is a bone conduction headphone, an intelligent wearable device and/or a hearing aid.

7. A computer readable storage medium having an audio signal processing program stored thereon, wherein when the audio signal processing program is executed by the processor, the steps of the audio signal processing method according to claim 1 are implemented.

8. The electronic device according to claim 5, wherein the first audio signal and the second audio signal are converted from time domain signals to frequency domain signals based on Fourier transform.

9. The electronic device according to claim 5, wherein before the step of processing the first audio signal and the second audio signal according to the frequency division value to obtain the audio output signal of the electronic device, the method further comprises:
performing noise reduction processing on the first audio signal and the second audio signal,
the step of processing the first audio signal and the second audio signal according to the frequency division value to obtain the audio output signal of the electronic device comprises:
processing the first audio signal and the second audio signal after noise reduction processed according to the frequency division value to obtain the audio output signal of the electronic device.

10. The electronic device according to claim 5, wherein the electronic device comprises at least two microphones, and the step of acquiring the first audio signal received by the bone conduction sensor and the second audio signal received by the microphone comprises:
acquiring the first audio signal received by the bone conduction sensor; and
acquiring the second audio signal according to at least two microphone audio signals received by the at least two microphones.

11. The computer readable storage medium according to claim 7, wherein the first audio signal and the second audio signal are converted from time domain signals to frequency domain signals based on Fourier transform.

12. The computer readable storage medium according to claim 7, wherein before the step of processing the first audio signal and the second audio signal according to the frequency division value to obtain the audio output signal of the electronic device, the method further comprises:
performing noise reduction processing on the first audio signal and the second audio signal,
the step of processing the first audio signal and the second audio signal according to the frequency division value to obtain the audio output signal of the electronic device comprises:
processing the first audio signal and the second audio signal after noise reduction processed according to the frequency division value to obtain the audio output signal of the electronic device.

13. The computer readable storage medium according to claim 7, wherein the electronic device comprises at least two microphones, and the step of acquiring the first audio signal received by the bone conduction sensor and the second audio signal received by the microphone comprises:
acquiring the first audio signal received by the bone conduction sensor; and
acquiring the second audio signal according to at least two microphone audio signals received by the at least two microphones.
